(19) United States
(12) Patent Application Publication
(10) Pub. No.: US 2013/0175426 A1
(43) Pub. Date: Jul. 11, 2013

(54) MULTI-MODE HOLDER FOR ELECTRONIC DEVICE

(71) Applicant: HHC Patents, Inc. a Delaware Corp., Long Beach, CA (US)

(72) Inventors: Nand Hotchand Harjani, Long Beach, CA (US); Benjamin Edmund Hopkins, Los Angeles, CA (US); Devin Marlow Connolly, Los Angeles, CA (US)

(73) Assignee: HHC Patents, Inc. a Delaware Corp., Long Beach, CA (US)

(21) Appl. No.: 13/737,814

(22) Filed: Jan. 9, 2013

Related U.S. Application Data
(60) Provisional application No. 61/584,794, filed on Jan. 9, 2012.

(51) Int. Cl. F16M 11/00

(52) U.S. Cl. CPC F16M 11/00
USPC 248/688

(57) ABSTRACT

A stand for an electronic device such as a mobile phone retains the electronic device by the device being slid between a front surface and at least four retention points. Some versions have four retention points in essentially a square pattern thus allowing the device to be slid into a retaining position in two distinct orthogonal directions. This provides for both a portrait and a landscape support configuration. Some embodiments have a leg that also acts as a hook or a clip.

### RELATED APPLICATIONS

This application claims the benefit of U.S. provisional application Ser. No. 61/584794 filed on Jan. 9 2012. That application is herein incorporated in its entirety.

### FIELD

This relates to holders and stands for electronic devices.

### BACKGROUND

There are a wide range of stands and holders for electronic devices. There are table stands, gooseneck stands, and stands for securing devices to a wall or dashboard. Some are for temporary use and others are essentially for mounting the electronic device in one place. With the wide range of capabilities and uses portable electronic devices have, it is hard to anticipate the various environments and positions in which it might be desirable to support such devices as smart phones and tablets.

### SUMMARY

Embodiments of a holder with a hook that is shaped to also be a leg or prop are presented. Some versions of a holder are presented that accommodate an electronic device to be slidably retained with some allowing slideable retention in two orthogonal directions.

### BRIEF DESCRIPTION OF THE DRAWINGS

FIG. 1 shows a first embodiment stand in a front perspective view secured to an electronic device shown in dashed lines;

FIG. 2 shows the stand of FIG. 1 in a rear perspective view secured to an electronic device shown in dashed lines;

FIG. 3 is a front view of the device of FIG. 1 supporting an electronic device in portrait mode;

FIG. 4 is a front view of the device of FIG. 1 supporting an electronic device in landscape mode;

FIG. 5 is a side view of the device and configuration of FIG. 4;

FIG. 6 is a side view of the device of FIG. 1 being supported on a horizontal surface in a 25-degree tilt-back mode;

FIG. 7 is a side view of the device of FIG. 1 being supported on a horizontal surface in a 70-degree tilt-back mode;

FIGS. 8A, 8B, and 8C show a progression of position of an electronic device being slid into the stand of FIG. 1 from top to bottom into a portrait mode;

FIGS. 9A, 9B, and 9C show a progression of position of an electronic device being slid into the stand of FIG. 1 from right to left into a landscape mode;

FIG. 10 shows a 2^{nd} embodiment of a stand from the front;

FIG. 11 shows the stand of FIG. 10 from the side;

FIG. 12 shows the stand of FIG. 10 FIG. in perspective;

FIG. 13 shows the stand of FIG. 10 being supported in a tilted back position on a horizontal surface;

FIG. 14 shows a 3rd embodiment of a stand in perspective;

FIG. 15 shows a 4th embodiment of a stand from the side;

FIG. 16 shows the embodiment of FIG. 15 in perspective;

FIG. 17 shows the embodiment of FIG. 15 from the side being supported leaning backward on a horizontal surface.

### DETAILED DESCRIPTION

In conjunction with the included drawings this detailed description is intended to impart an understanding of the teachings herein and not to define their metes and bounds.

### Structure and Operation

To retain the subject electronic device in a portrait orientation it is slid in from the top. Arms of the four brackets wrap around the right and left edges. The device is held in place by a resilient force of the bracket arms pressing towards the front surface of the base at the perimeter of the front face of the electronic device.

To retain the subject device in a landscape orientation, it is slid in from the side, between the arms. In this case, the side edges of the electronic device press against the brackets. As seen in FIG. 2 the contact surfaces of the arm 123 that contact the electronic devices edges have a curvature that is the compliment of the curvature of the device edges.

The four electronic device positions are achieved by the two stand-to-table options times the two electronic-device-to-stand options.

In addition, the stand can be turned 180-degrees into a hook mode. As in the stand positions, the electronic device can be inserted into the base in both a portrait and a landscape orientation.

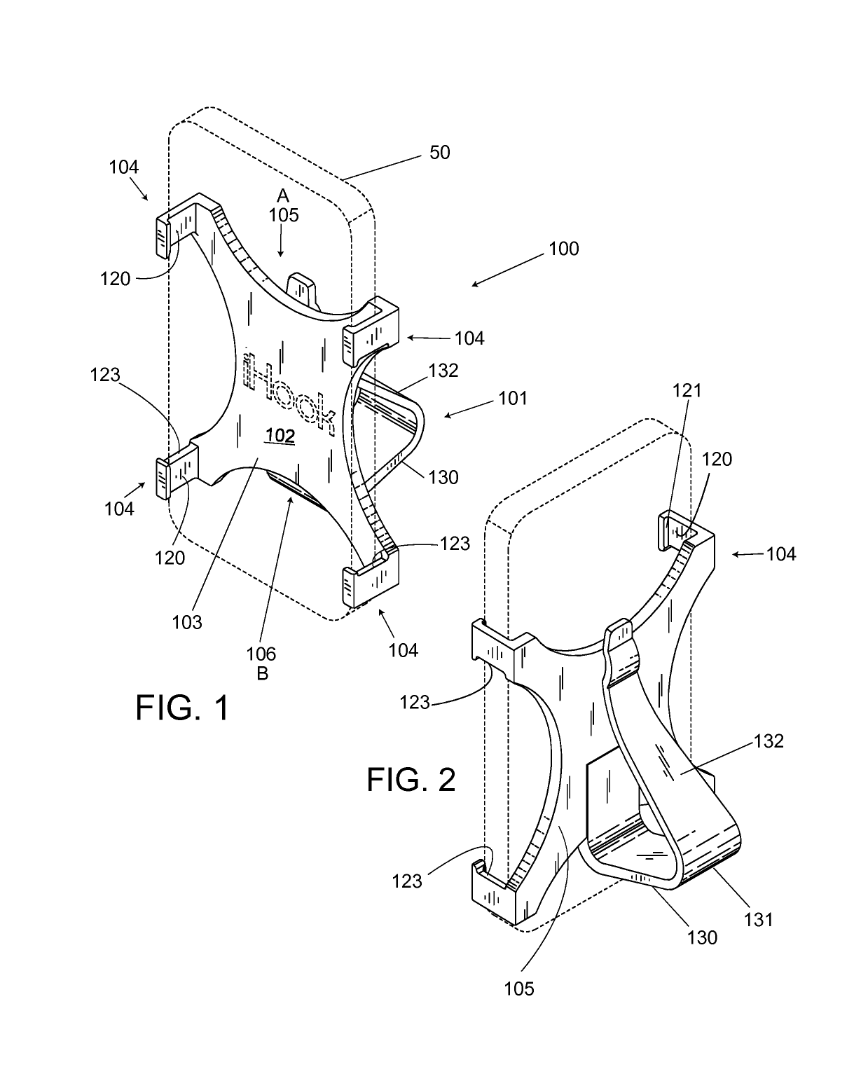

A first embodiment is seen in FIGS. 1-9. This embodiment is mechanically coupled to the electronic device it is sized for by sliding the device in between a back wall and four bracket arms. FIG. 1 shows a perspective view of this first embodiment stand 100 holding an electronic device 50 shown on a dashed line. The two main parts of the stand are its leg 101 and the base holder 102. The holder has for retaining arms 104 and a front surface 103 and a back surface 105. Because of the wide flexibility in use and mounting the “upper” and “lower” extremities will be referred to as the A end 105 and the B end 106.

As seen in FIGS. 1 and 2 the arms 104 have several regions, each with its own function. The inside surfaces of the arms 120 face each other in a left-right direction and provide a part of the retention force to hold a portrait mode device to the holder. The lip 121 of the arm provides additional force in the portrait mode. Those regions can produce a force tending to urge the electronic device to the front surface 103 of the holder.

As will be seen in FIGS. 4 and 5 the electronic device, a smart phone for example, can also be retained to the holder in a landscape mode. In that mode the thin surfaced 123 provide the force that retains the phone.

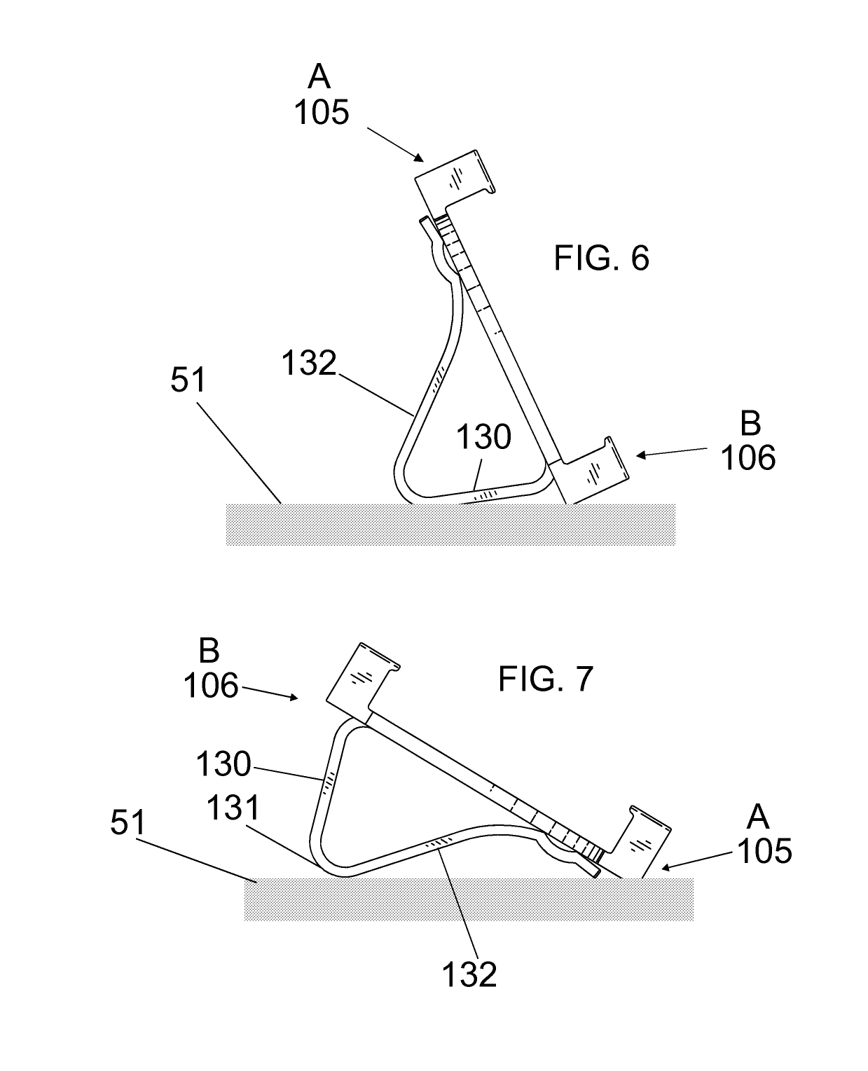

The second major portion of the stand of this first example is the leg 101. As seen in FIGS. 2 and 5 there are three structural features of the leg. There is a short portion 130 attached to the holder. It meets a longer leg portion 132 in an acute angle at a knee 131. As will be seen in FIGS. 6 and 7 the leg can be used to hold the stand in two distinct positions. It is also clear that the leg is also usable as a clip or hook. To use it as a clip or hook, the B end 106 would be up and the A end 105 would be down.

FIG. 6 shows the stand on a horizontal surface 51 resting on the short portion 130 of the leg. This configuration holds a phone at about 70-degrees from the surface. FIG. 7 is an alternate configuration with the A end 105 and the knee 131 resting on the surface. That results in about a 25-degree tilt up from the surface.

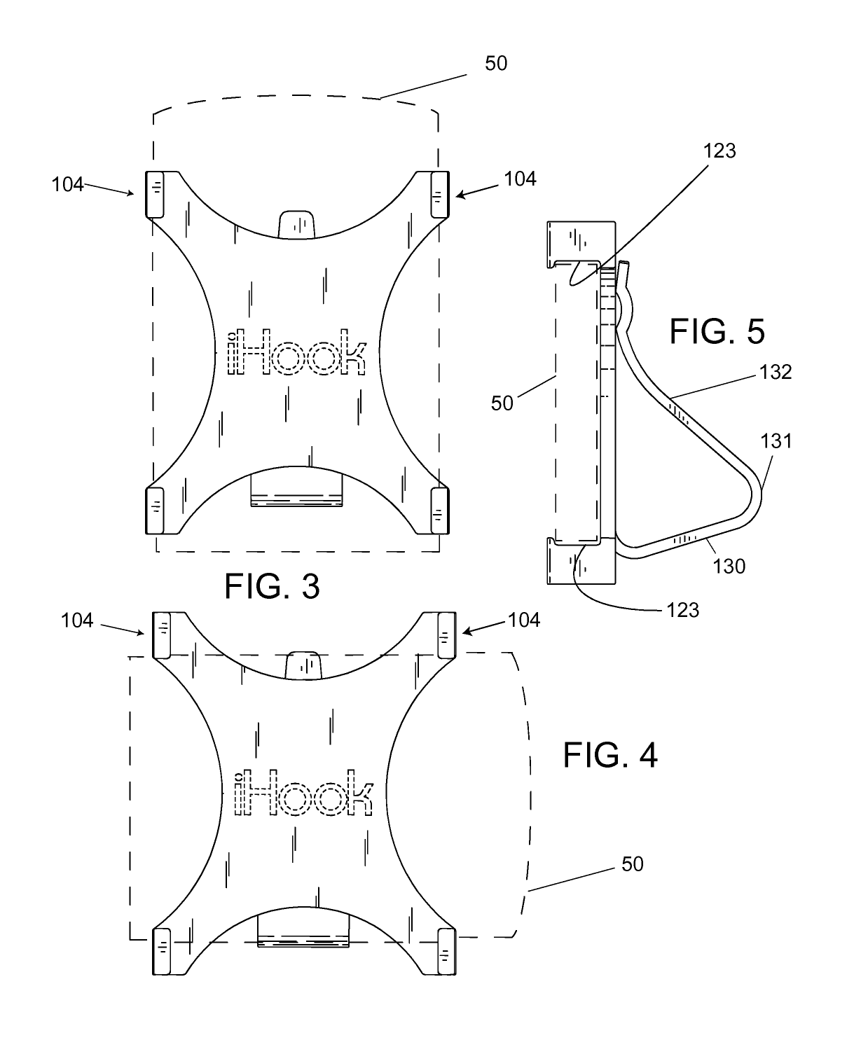

Both ways of inserting a phone involve sliding. The arms provide frictional and resilient retaining forces to hold in an inserted phone. This works to support both the portrait mode of FIG. 3 and the landscape mode of FIG. 4. There is essentially a square pattern defined by the arms. The distance from a left retaining region 120 and its opposing right retaining region 120 is an interference fit with the width of the phone. To support the landscape mode where the phone is slid in from the side, the A end 105 facing retaining edge 123 is that same distance from its opposing B end 106 facing edge 123.

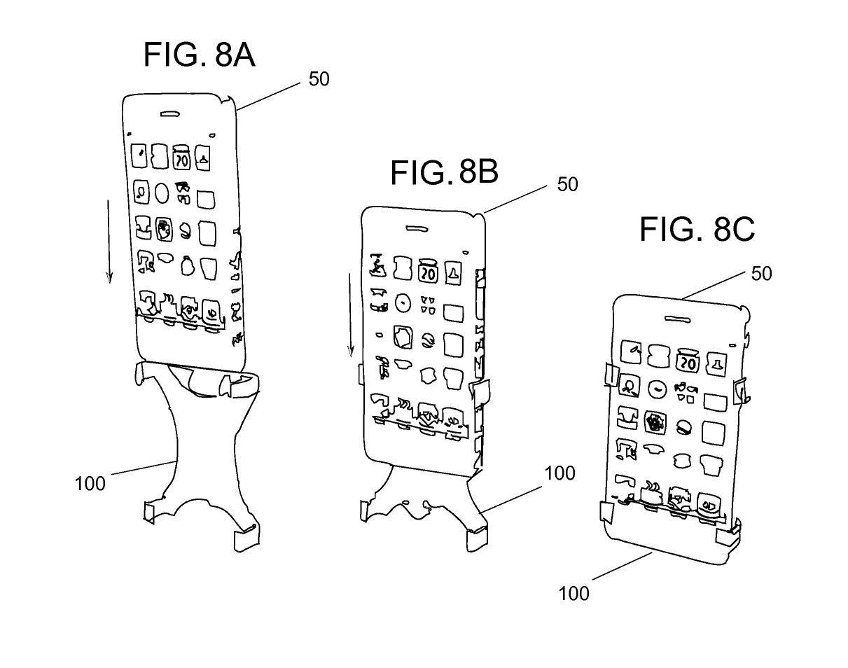

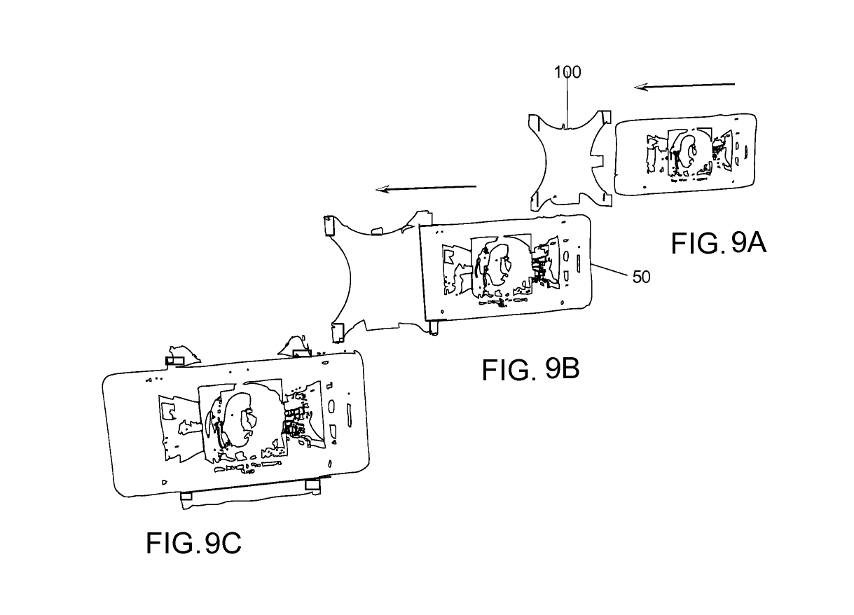

FIGS. 8A, 8B and 8C show a sequence of a downward sliding of a phone 50 into the stand 100 between the arms resulting in a portrait mode configuration. Analogously FIGS. 9A, 9B and 9C show a sequence of inserting a phone in a right to left direction. This results in FIG. 9C with the phone in a landscape configuration.

These multiple ways of supporting a device are very complimentary with the ability of many of these devices to readily and automatically change the orientation of the material displayed.

### Second Embodiment

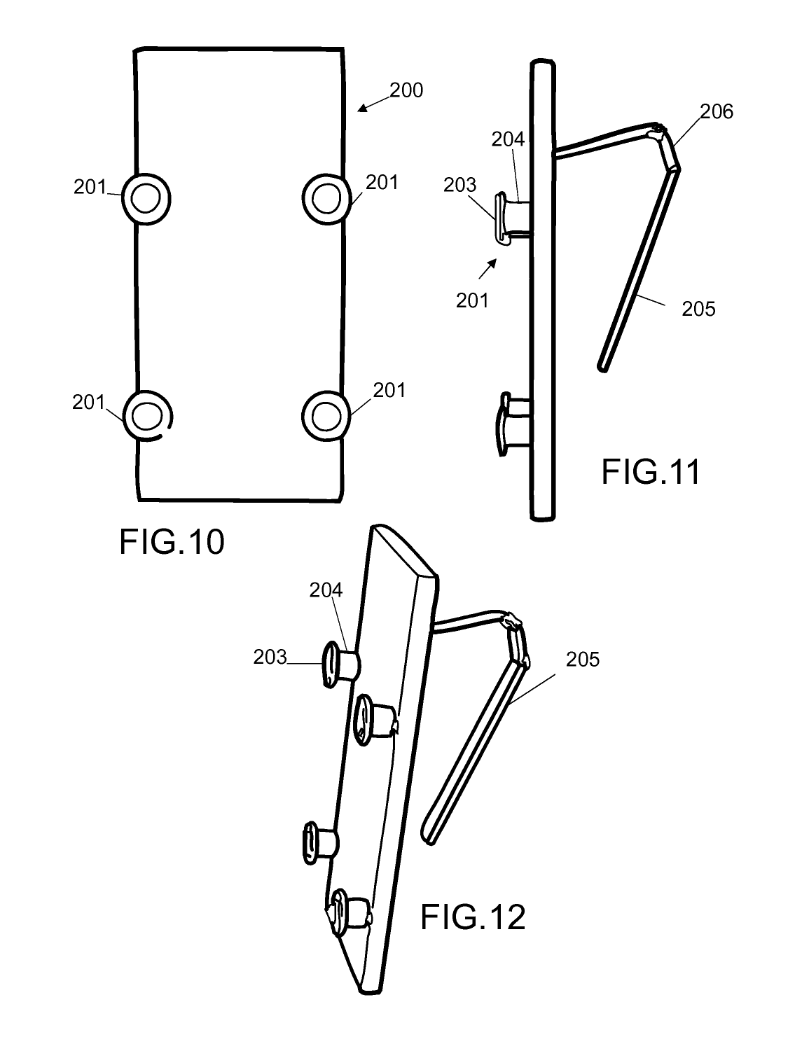

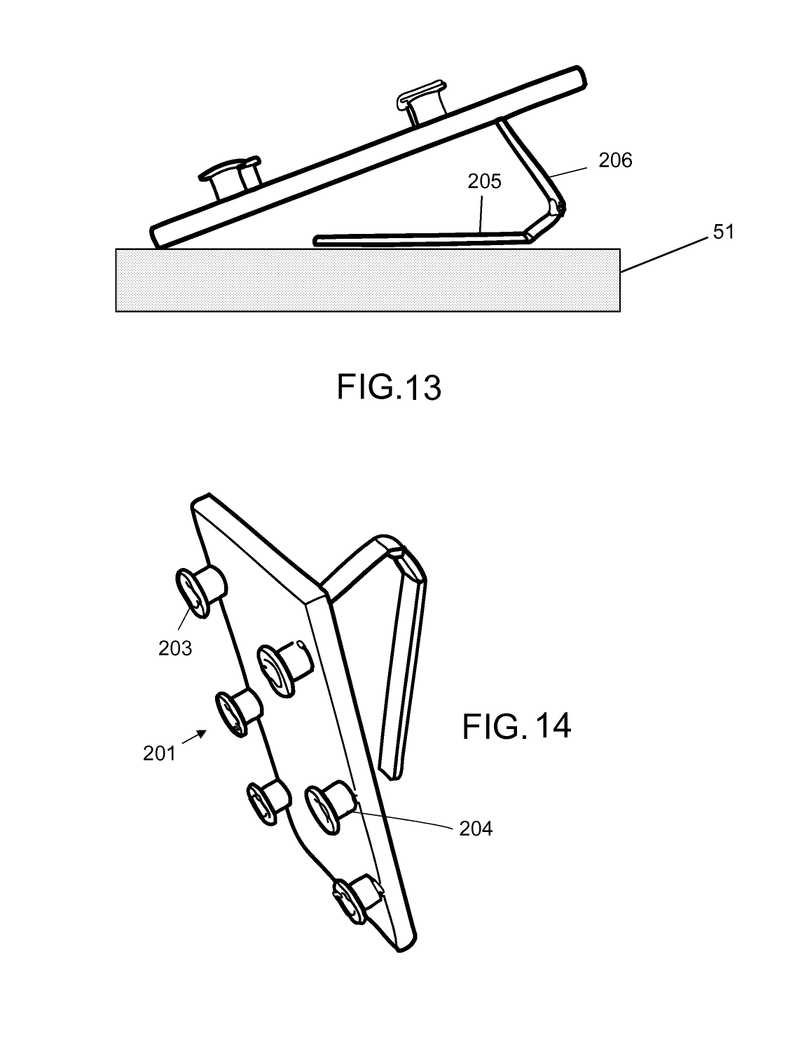

FIGS. 10-13 show a second embodiment stand 200. It has a solid rectangular holder base 210 and four identical cylindrical posts 201 in a square pattern. Each post has a retaining cylinder 204 and is topped by a stop disk 203. The distance between the posts minus the diameter of the retaining cylinder is the width of the intended phone. As seem in FIGS. 11 and 12 this embodiment has a leg/hook 205 with a knee 206. Unlike the first embodiment this unit has only one position it can be supported by a horizontal surface 51 as seen in FIG. 13. It is resting on the distal length of the leg. The shape of the leg makes it also suitable to use as a hook, although it does not have the clip capability that the first embodiment enjoys.

### Third Embodiment

Seen only in FIG. 14 the third embodiment has two additional posts 201. This provides a more secure retention but allows the phone only to be slid in from the top or bottom, not the sides.

### Fourth Embodiment

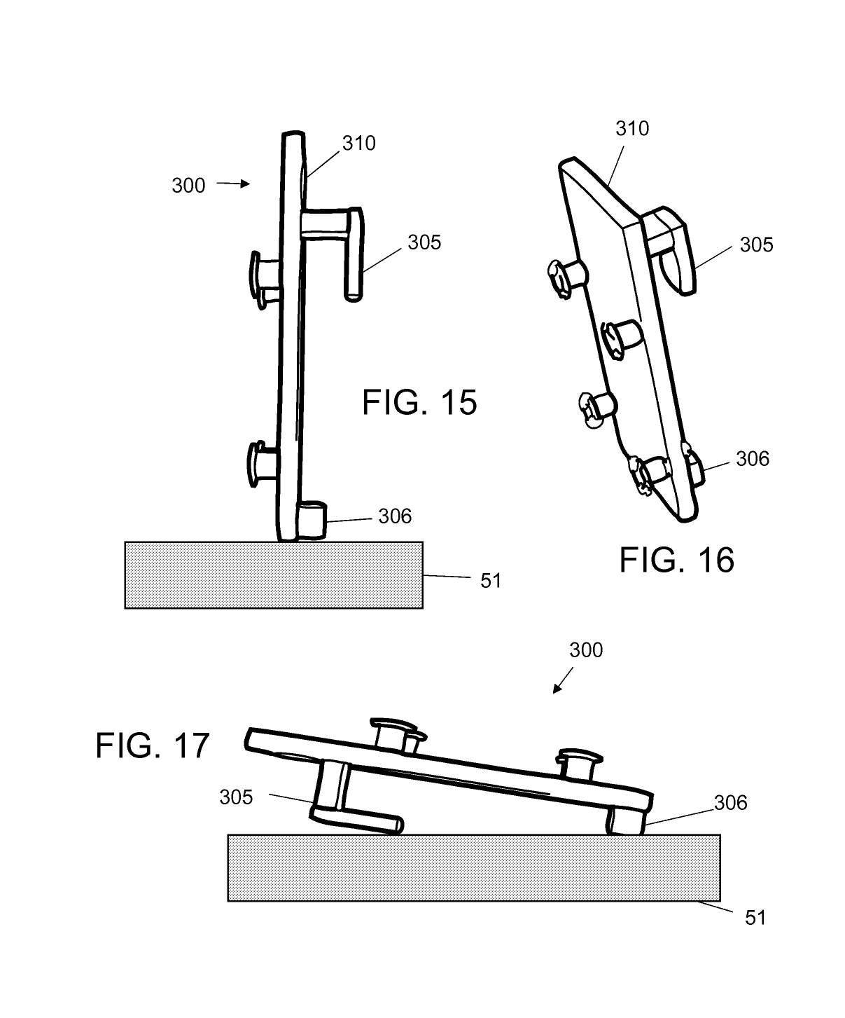

The fourth version, as seen in FIGS. 15 and 16, has a holder base 310 and retention posts like those of the second embodiment. It differs in its leg arrangement. There are two distinct structures on the back surface of the holder. One is a hook 305 and the other is a foot 306. This configuration allows for hanging and for standing up relatively straight on a horizontal surface 51 as seen in FIG. 15. FIG. 17 shows this embodiment supported by its foot 306 and its hook 305 laying at a 75 degree angle on a horizontal surface 51.

The retaining cylinders of embodiments 2, 3 and 4 can be smooth surfaces at precise distances. Alternatively, they might be made of a foam or other soft surface. A third alternative is that they are rollers.

Those skilled in the art will be aware of materials, techniques, and equipment suitable to produce the example embodiments presented as well as variations on the those examples. This teaching is presented for purposes of illustration and description but is not intended to be exhaustive or limiting to the forms disclosed. Many modifications and variations will be apparent to those of ordinary skill in the art. The embodiments and versions help to explain the principles of the invention, the practical application, and to enable others of ordinary skill in the art to understand it. Various embodiments with various modifications as are suited to the particular application contemplated are expected.

In the following claims, the words “a” and “an” should be taken to mean “at least one” in all cases, even if the wording “at least one” appears in one or more claims explicitly. The scope of the invention is set out in the claims below.

What is claimed:

1. A stand for an electronic device with four retention regions in a square pattern such that, without the need for fasteners, an electronic device that has two opposing parallel edges can be retained to a holder in a sliding motion in two distinct orthogonal positions, further the holder has a generally triangular leg providing for supporting the electronic device on a horizontal surface at two distinct angles, the angle being selected by choosing one of two ends of the stand to place at the foot position on the surface.

2. A stand for an electronic device with four retention regions in a square pattern such that, without the need for fasteners, an electronic device that has two opposing parallel edges an be retained to a holder in a sliding motion in two distinct orthogonal positions, further the holder has a leg providing for supporting the electronic device on a horizontal surface and has a hook for supporting the electronic device by retention to a raised horizontal edge.

3. The stand of claim 2 where the leg and the hook are integrated.

4. A stand for an electronic device with four retention regions such that an electronic device can retained to a holder in a sliding motion; further, the stand has a leg providing for supporting the electronic device on a horizontal surface and the stand has a hook for supporting the electronic device by retention to a raised horizontal structure.

5. The stand of claim 4 where the leg and hook are integrated.
